(19) United States
(12) Patent Application Publication
(10) Pub. No.: US 2024/0198800 A1
(43) Pub. Date: Jun. 20, 2024

(54) VEHICLE DISPLAY CONTROL DEVICE, VEHICLE DISPLAY CONTROL METHOD, AND RECORDING MEDIUM FOR A VEHICLE

(71) Applicant: TOYOTA JIDOSHA KABUSHIKI KAISHA, Toyota-shi (JP)

(72) Inventors: Hideki TSUDA, Nagoya-shi (JP); Toshinori AOKI, Toyota-shi (JP)

(73) Assignee: TOYOTA JIDOSHA KABUSHIKI KAISHA, Toyota-shi (JP)

(21) Appl. No.: 18/512,572

(22) Filed: Nov. 17, 2023

(30) Foreign Application Priority Data
Dec. 16, 2022 (JP) 2022-201620

(51) Int. Cl. B60K 35/00

(52) U.S. Cl. CPC B60K 35/00; B60K 2370/1529; B60K 2370/177; B60K 2370/1868; B60K 2370/52

(57) ABSTRACT

A vehicle display control device including at least one processor, the at least one processor being configured to generate a linear superimposed image indicating a travel path of a vehicle by being drawn so as to be superimposed on a landscape at a vehicle front side and extend toward the vehicle front side, and carry out control so as to change a direction in which a leading end side of the superimposed image faces, according to a road curvature, based on road information for the vehicle front side.

### CROSS-REFERENCE TO RELATED APPLICATION

This application is based on and claims priority under 35 USC 119 from Japanese Patent Application No. 2022-201620 filed on Dec. 16, 2022, the disclosure of which is incorporated by reference herein.

### BACKGROUND

### Technical Field

The invention of the present disclosure relates to a vehicle display control device, a vehicle display control method, and a recording medium for a vehicle.

### Related Art

Japanese Patent Application Laid-Open (JP-A) No. 2019-113809 discloses a head-up display device. In this head-up display device, it has been proposed to perform course guidance by displaying an image in which an arrow serving as an AR object is linearly arranged, so as to be superimposed on a landscape at a vehicle front side.

Incidentally, in driving assistance such as lane change assistance (LCA) or the like, in a case in which a linear superimposed image indicating a travel path of a vehicle is displayed, a leading end of the superimposed image faces a progression direction after travel corresponding to a lane change or the like.

However, if a road is curved at a front side, there are cases in which there is deviation between a direction in which the leading end of the superimposed image faces and a direction of the road at the front side, causing a sense of incongruity for an occupant.

### SUMMARY

In consideration of the above facts, an object of the present disclosure is to provide a vehicle display control device, a vehicle display control method, and a recording medium for a vehicle that can reduce a sense of incongruity of an occupant who has viewed a display in a case in which an image indicating a travel path is displayed so as to be superimposed on a landscape at a vehicle front side.

A vehicle display control device according to a first aspect of the present disclosure includes: an image generation section configured to generate a linear superimposed image indicating a travel path of a vehicle by being drawn so as to be superimposed on a landscape at a vehicle front side and extend toward the vehicle front side; and an image control section configured to control the image generation section so as to change a direction in which a leading end side of the superimposed image faces, according to a road curvature, based on road information for the vehicle front side.

In the vehicle display control device according to the first aspect of the present disclosure, the linear superimposed image that is superimposed on the landscape at the vehicle front side is generated. The superimposed image is drawn so as to extend toward the vehicle front side, to thereby indicate the travel path of the vehicle. Consequently, an occupant can confirm the travel path without moving a line of sight from the vehicle front side.

In the vehicle display control device, the direction in which the leading end side of the superimposed image faces is changed according to the road curvature, based on the road information for the vehicle front side. Accordingly, for example, in a case in which the road ahead is curved, the leading end side of the superimposed image is shown so as to be inclined in correspondence to the curvature of the road. Consequently, since the path shape shown by the superimposed image is made to match with the landscape at the vehicle front side, a sense of incongruity of the occupant who has viewed the superimposed image can be reduced.

A vehicle display control device according to a second aspect of the present disclosure is the configuration according to the first aspect, wherein: the superimposed image indicates a travel path that accompanies a lane change; and the image control section is configured to change the direction in which the leading end side of the superimposed image, which indicates the travel path after the lane change, faces, according to the road curvature.

In the vehicle display control device according to the second aspect of the present disclosure, a sense of incongruity of the occupant who has viewed the superimposed image can be reduced in a case in which a lane change is performed at a point where the road ahead is curved.

A vehicle display control device according to a third aspect of the present disclosure is the configuration according to the first aspect or the second aspect, wherein: the superimposed image has a linear shape connecting a coordinate point of a current position of the vehicle and a coordinate point of an estimated arrival position on the travel path, by curve interpolation; and the image control section is configured to change a shape of a leading end side of a curved line obtained by the curve interpolation, according to the road curvature.

In the vehicle display control device according to the third aspect of the present disclosure, the linear travel path is shown by connecting the coordinate point of the present position of the vehicle and the coordinate point of the estimated arrival position on the travel path, by curve interpolation. Moreover, in the vehicle display control device, by changing the shape of the leading end side of the curve obtained by the curve interpolation according to the road curvature, an image corresponding to the road shape at the front side can be generated. Consequently, the course indicated by the superimposed image is made to match with the landscape at the vehicle front side, in comparison to a case in which the travel path is illustrated using only the curve interpolation method. As a result, a sense of incongruity of the occupant who has viewed the superimposed image can be reduced.

A vehicle display control method according to a fourth aspect of the present disclosure includes: generating a linear superimposed image indicating a travel path of a vehicle by being drawn so as to be superimposed on a landscape at a vehicle front side and extend toward the vehicle front side; and changing a direction in which a leading end side of the superimposed image faces, according to a road curvature, based on road information for the vehicle front side.

A vehicle display control program according to a fifth aspect of the present disclosure is executable by a computer to perform processing including: generating a linear superimposed image indicating a travel path of a vehicle by being drawn so as to be superimposed on a landscape at a vehicle front side and extend toward the vehicle front side; and changing a direction in which a leading end side of the superimposed image faces, according to a road curvature, based on road information for the vehicle front side.

As described above, according to the vehicle display control device, the vehicle display control method, and the vehicle display control program according to the present invention, a sense of incongruity of an occupant who has viewed a display can be reduced in a case in which an image indicating a travel path is displayed so as to be superimposed on a landscape at a vehicle front side.

### BRIEF DESCRIPTION OF THE DRAWINGS

Exemplary embodiments of the present invention will be described in detail based on the following figures, wherein:

FIG. 1 is a schematic diagram illustrating a front portion within a vehicle cabin of a vehicle to which a vehicle display control device according to the present exemplary embodiment has been applied, as viewed from a vehicle rear side;

FIG. 2 is a block diagram illustrating a hardware configuration of the vehicle display control device;

FIG. 3 is a block diagram illustrating a functional configuration of the vehicle display control device;

FIG. 4 is a schematic diagram for explaining functionality of an image control section according to the present exemplary embodiment;

FIG. 5 is a diagram illustrating an example of display of a superimposed image according to the present exemplary embodiment; and

FIG. 6 is a flow chart illustrating an example of a flow of display processing in the present exemplary embodiment.

### DETAILED DESCRIPTION

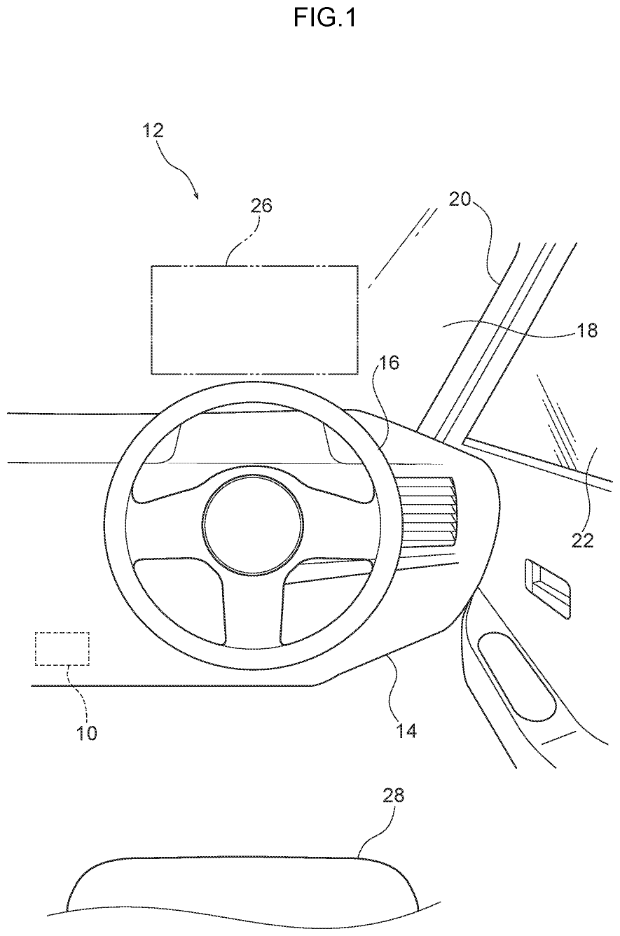

A vehicle display control device 10 according to the present exemplary embodiment will be explained below, with reference to FIG. 1 to FIG. 6.

As illustrated in FIG. 1, an instrument panel 14 is provided at a front portion within a vehicle cabin of a vehicle 12. The instrument panel 14 extends in a vehicle width direction, and a steering wheel 16 is provided at a vehicle right side of the instrument panel 14. Namely, in the present exemplary embodiment, as an example, the vehicle is configured as a right hand drive vehicle in which the steering wheel 16 is provided at the right side, and a driver's seat 28 is established at the vehicle right side.

A windshield glass 18 is provided at a front end portion of the instrument panel 14. The windshield glass 18 extends in a vehicle up-down direction and in the vehicle width direction to partition a vehicle cabin interior and a vehicle cabin exterior.

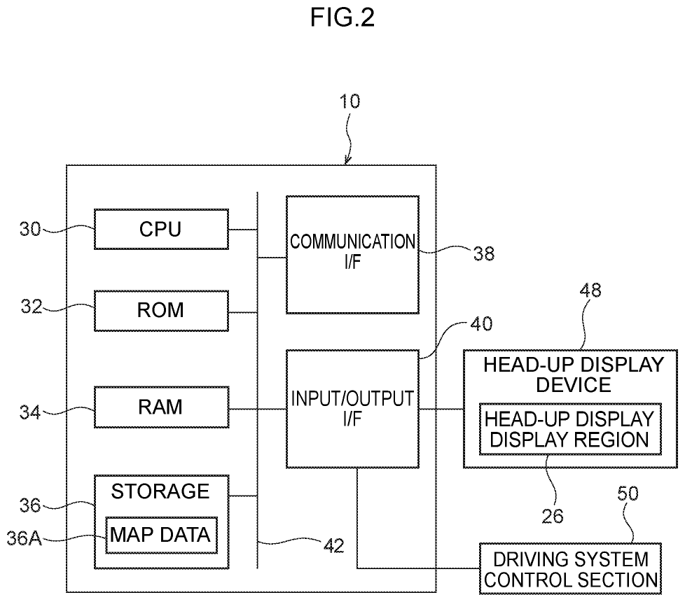

At a front side of the driver's seat 28, a head-up display region 26 (hereafter simply referred to as a “display region 26”) is provided at the windshield glass 18. The display region 26 is configured by a projection plane projected by a head-up display device 48 (refer to FIG. 2) serving as a vehicle display device. More specifically, the head-up display device 48 is provided at a vehicle front side of the instrument panel 14, and a configuration is provided such that an image is projected from the head-up display device 48 onto the display region 26 of the windshield glass 18. Namely, the display region 26 is configured as a part of the windshield glass 18 serving as the projection plane of the head-up display device 48.

The vehicle display control device 10 is provided at the vehicle 12. The vehicle display control device 10 of the present exemplary embodiment is configured by, for example, one or more electronic control units (ECUs).

### Hardware Configuration of Vehicle Display Control Device 10

FIG. 2 is a block diagram illustrating a hardware configuration of the vehicle display control device 10. As illustrated in FIG. 2, the vehicle display control device 10 is configured to include a central processing unit (CPU; processor) 30, a read only memory (ROM) 32, a random access memory (RAM) 34, a storage 36, a communication interface (communication I/F) 38, and an input/output interface (input/output I/F) 40. These configurations are connected via a bus 42 so as to be capable of communicating with each other.

The CPU 30 is a central arithmetic processing unit, and the CPU 30 executes various programs and controls various sections. Namely, the CPU 30 reads a program from the ROM 32 or the storage 36, and executes the program using the RAM 34 as a workspace.

The CPU 30 carries out control of the respective configurations and various kinds of arithmetic processing according to programs recorded in the ROM 32 or the storage 36.

The ROM 32 stores various programs and various data. The RAM 34 serves as a workspace to temporarily store programs and data. The storage 36 is configured by a hard disk drive (HDD) or a solid state drive (SSD), and stores various programs including an operating system, as well as various data. In the present exemplary embodiment, the ROM 32 or the storage 36 stores a program for performing display processing, which will be described later, and various data such as map data 36A and the like.

The communication I/F 38 is an interface used by the vehicle display control device 10 to communicate with an external server and other equipment, and employs a standard such as, for example, Controller Area Network (CAN), Ethernet (registered trademark), Long Term Evolution (LTE), Fiber Distributed Data Interface (FDDI), Wi-Fi (registered trademark), or the like.

The input/output I/F 40 is electrically connected to the head-up display device 48 and a driving system control section 50.

The head-up display device 48 displays predetermined information at the display region 26 of the windshield glass 18.

The driving system control section 50 is a control device that controls various driving systems installed at the vehicle 12, and is configured by, for example, one or more electronic control units (ECUs). The various driving systems include autonomous driving systems and travel assistance systems. The travel assistance systems include various advanced driving assistant systems (ADAS), such as a stop system or a start system for avoiding contact between a detected object and the vehicle 12, an adaptive cruise control (ACC) system, a lane tracing assistance (LTA) system, lane change assistance (LCA) and the like. The driving system control section 50 controls various actuators installed at the vehicle 12 to automatically perform some or all of operation of an accelerator, a brake, a direction indicator, steering, and the like of the vehicle 12, and thereby actuate various driving systems.

### Functional Configuration of Vehicle Display Control Device 10

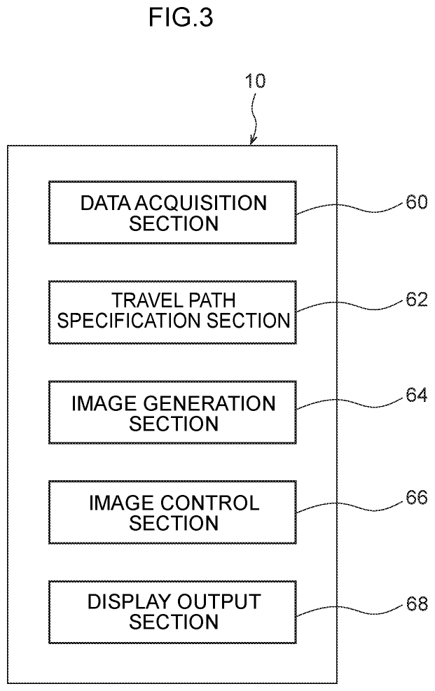

The vehicle display control device 10 implements various functionality using the aforementioned hardware resources. Functional configuration implemented by the vehicle display control device 10 will be explained, with reference to FIG. 3.

As illustrated in FIG. 3, the vehicle display control device 10 is configured to include a data acquisition section 60, a travel path specification section 62, an image generation section 64, an image control section 66, and a display output section 68, as functional configuration. The respective functional configuration is implemented by the CPU 30 reading and executing programs stored in the ROM 32 or the storage 36.

The data acquisition section 60 acquires information relating to control of the driving systems, based on a signal transmitted from the driving system control section 50. Further, the data acquisition section 60 acquires coordinates of a current position of the vehicle 12, based on a signal from a global positioning system (GPS) sensor, which is not illustrated in the drawings. Moreover, the data acquisition section 60 acquires map data 36A of a periphery of the coordinates of the current position of the vehicle 12, from the storage 36. It should be noted that the map data 36A may be acquired from an external server that is connected to a network, via the communication I/F 38.

In the present exemplary embodiment, the data acquisition section 60 acquires road information for a front side of the vehicle 12. More specifically, for example, road information within a range of a distance that can be confirmed at the windshield glass 18 by an occupant seated in the driver's seat 28 is acquired. The road information includes information relating to a road shape. The road information may be acquired from high-precision map data, or may be acquired from an image obtained by photographing the front side of the vehicle 12 by an onboard camera.

The travel path specification section 62 specifies a travel path of the vehicle 12 based on the information relating to control of the driving systems and the map data 36A for the vehicle periphery that have been acquired by the data acquisition section 60. For example, in a case in which operation of a predetermined driving system has been detected or predicted, a travel path of the vehicle 12 corresponding to the driving system is specified.

In an example of the present exemplary embodiment, the travel path of the vehicle 12 is specified by connecting a coordinate point of the current position of the vehicle of the vehicle 12 and a coordinate point of an estimated arrival position on the travel path, by curve interpolation. Known curve interpolation techniques typified by spline interpolation, Lagrangian interpolation, Newtonian interpolation, and the like can be applied to this curve interpolation.

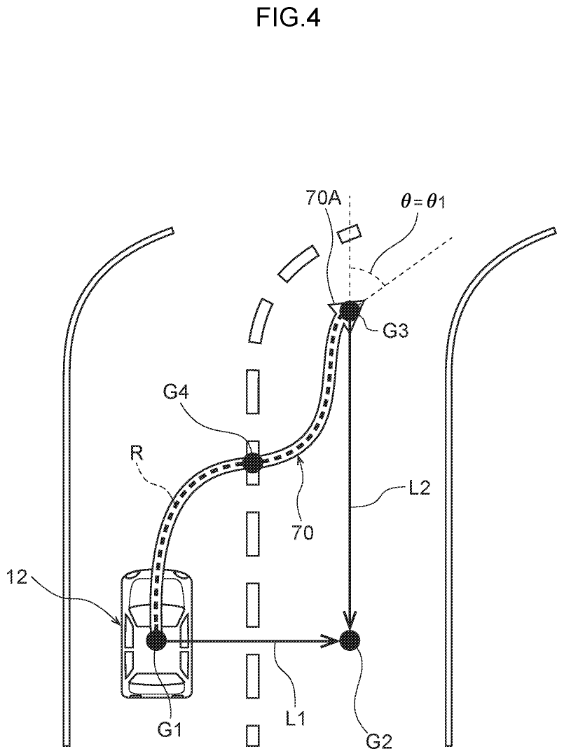

As an example, a method of specifying a travel path when a lane change assistance (LCA) system is operated will be explained, with reference to FIG. 4. During operation of the LCA system, spline interpolation is used to identify a travel path R of the vehicle 12 that accompanies a lane change. Based on a coordinate point G1 of the current position of the vehicle, the travel path specification section 62 calculates a coordinate point G2 of a position offset from the coordinate point G1 toward a lane after the lane change by a distance L1 corresponding to a width of the lane. Moreover, a coordinate point G3 of a position that is advanced from the coordinate point G2 toward a progression route forward side by a predetermined distance L2 that is required for the lane change is calculated. The travel path specification section 62 identifies the coordinate point G3 as the estimated arrival position on the travel path accompanying the lane change. Then, a coordinate point G4 of an intermediate position that connects the coordinate point G1 of the current position and the coordinate point G3 of the estimated arrival position is calculated, and a spline curve that passes through the coordinate points G1, G4 and G3 is generated as the travel path R of the vehicle 12.

The image generation section 64 generates a superimposed image indicating the travel path of the vehicle 12, based on the travel path specified by the travel path specification section 62. The superimposed image is configured by an AR image. The AR image is an image that is drawn using Augmented Reality technology. Namely, the landscape at the front side of the vehicle 12 is visible in the display region 26 through the windshield glass 18, and the superimposed image is displayed so as to be superimposed on this landscape. The superimposed image is drawn in a linear shape so as to extend toward the front side of the vehicle 12. Further, a leading end object capable of suggesting a direction is arranged at a leading end side of the superimposed image.

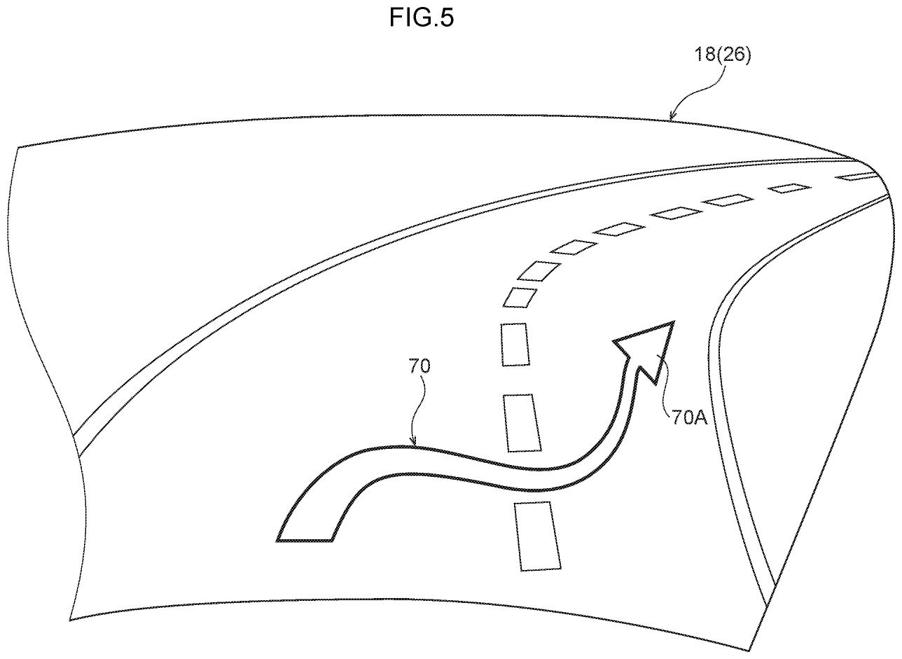

If the time of operation of the LCA system is explained as an example, as illustrated in FIG. 5, a linear superimposed image 70 having a spline curve shape is displayed so as to be superimposed on the landscape at the front side of the vehicle 12. Accordingly, a base end side of the superimposed image 70 is superimposed on the lane before the lane change, and the leading end side of the superimposed image 70 is superimposed on the lane after the lane change. Further, in the example illustrated in the drawing, a leading end object 70A arranged at the leading end side of the superimposed image 70 is an object having an arrow shape.

The image control section 66 controls the image generation section 64 based on the road information for the vehicle front side so that a direction in which the leading end side of the superimposed image faces changes according to a road curvature. More specifically, based on the road information for the front side of the vehicle 12 that has been acquired by the data acquisition section 60, the image control section 66 specifies a shape of the road at a progression route forward side. The image control section 66 then acquires the road curvature at the front side from the specified road shape, and performs control such that the direction in which the leading end side of the superimposed image faces is changed in accordance with the acquired road curvature. As an example, the image control section 66 may determine an inclination of the leading end side of the superimposed image based on a table in which the road curvature at the vehicle front side and an inclination angle θ with respect to a progression direction of the vehicle are associated with each other.

If the time of operation of the LCA system is explained as an example, in the example illustrated in FIG. 4, the direction in which the leading end object 70A arranged at the leading end side of the superimposed image 70 points changes according to the road curvature at the front side of the vehicle 12. In the example illustrated in the drawing, the road curves to the right ahead of the progression route of the vehicle 12. Consequently, the leading end object 70A points in a direction that is inclined toward the right side with respect to the progression direction of the vehicle 12 by a predetermined inclination angle θ1.

The display output section 68 causes the superimposed image generated by the image generation section 64 to be displayed in the display region 26 provided at the front side of the driver's seat. More specifically, the display output section 68 transmits output data of the superimposed image 70 to the head-up display device 48, and the transmitted image data is output by the head-up display device 48.

Due to the control by the image control section 66 described above, the linear travel path extending so as to straddle between the lane before the lane change and the lane after the lane change, and the superimposed image 70 in which the leading end side is inclined diagonally rightward in correspondence to the road shape that is curved to the right ahead of the progression route, are displayed in the display region 26 of the windshield glass 18. This enables the landscape at the front side of the vehicle 12 that is visible through the windshield glass 18 to be matched with the travel path indicated by the superimposed image 70.

### Operation of Display Processing

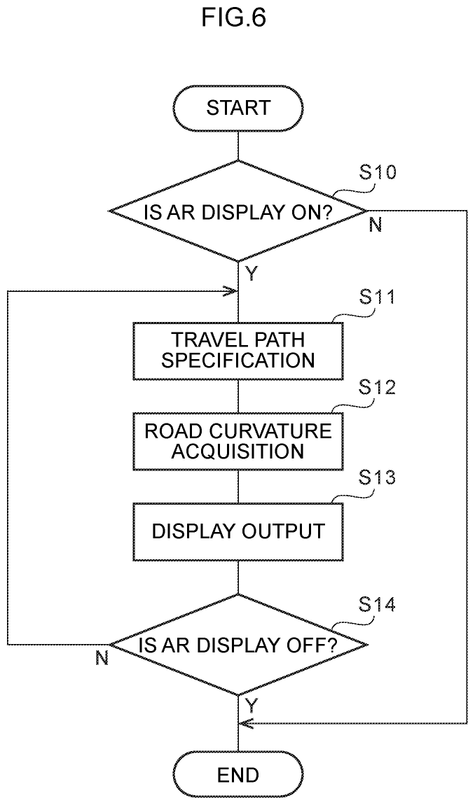

An example of operation of display processing executed by the vehicle display control device 10 will be explained, with reference to the flowchart illustrated in FIG. 6. This display processing is executed, for example, when an occupant actuates a predetermined driving system by operating an operation section provided within the vehicle cabin. The display processing is executed by the CPU 30 reading a program from the ROM 32 or the storage 36 and expanding the program in the RAM 34.

As illustrated in FIG. 6, at step S10, the CPU 30 determines whether or not a display function of the AR image is turned ON. It should be noted that turning ON/OFF of the display function of the AR image may be performed by an occupant operating a non-illustrated operation section that is provided within the vehicle cabin, or may be configured such that the display function is turned ON at the same time as the ignition is turned on. In a case in which the display function of the AR image is turned ON, the determination at step S10 is affirmative, and the CPU 30 proceeds to the processing at step S11. On the other hand, in a case in which the display function of the AR image is turned OFF, the CPU 30 ends the display processing.

At step S1, the CPU 30 specifies a travel path of the vehicle 12. More specifically, the functionality of the travel path specification section 62 is used to specify a travel path corresponding to a predetermined driving system for which operation has been detected or predicted. In the present exemplary embodiment, the travel path of the vehicle 12 is illustrated in a linear shape in which the coordinate point G1 of the current position of the vehicle and the coordinate point of the estimated arrival position G3 on the travel path are connected by curve interpolation.

At step S12, based on the road information for the front side of the vehicle 12 acquired by the data acquisition section 60, the CPU 30 acquires the road curvature of the road ahead of the progression route.

At step S13, the CPU 30 uses the functionality of the image generation section 64 to generate a superimposed image indicating the travel path of the vehicle 12. Further, the functionality of the image control section 66 is used to change the direction in which the leading end side of the superimposed image faces in accordance with the road curvature at the front side of the vehicle 12.

At step S14, the CPU 30 determines whether or not the display function of the AR image has been turned OFF. In a case in which the display function of the AR image has been turned OFF, the determination at step S10 is affirmative, and the CPU 30 ends the display processing. On the other hand, in a case in which the display function of the AR image is turned ON, the CPU 30 returns to the processing at step S11.

### Action and Effects

As described above, in the vehicle display control device 10 according to the present exemplary embodiment the linear superimposed image 70 that is superimposed on the landscape at the vehicle front side is generated, as illustrated in FIG. 5. The superimposed image 70 is drawn so as to extend toward the vehicle front side to thereby indicate the travel path of the vehicle. Consequently, the occupant can confirm the travel path without moving a line of sight from the vehicle front side.

In the vehicle display control device 10, the direction in which the leading end side of the superimposed image 70 faces is changed according to the road curvature, based on the road information for the vehicle front side. Accordingly, for example, in a case in which the road is curved at the front side, the leading end side of the superimposed image 70 is shown so as to be inclined in correspondence to the curvature of the road. Consequently, since the path shape shown by the superimposed image 70 is made to match with the landscape at the vehicle front side, a sense of incongruity of the occupant who has viewed the superimposed image 70 can be reduced.

In the example illustrated in FIG. 5, the superimposed image 70 shows a travel path accompanying a lane change. The vehicle display control device 10 changes the direction in which the leading end side of the superimposed image 70 indicating the travel path after the lane change faces, in accordance with the road curvature. Consequently, a sense of incongruity of the occupant who has viewed the superimposed image 70 can be reduced in a case in which a lane change is performed at a point where the road ahead is curved.

Further, as illustrated in FIG. 4, in the present exemplary embodiment, the linear travel path is shown by connecting the coordinate point G1 of the current position of the vehicle 12 and the coordinate point G3 of the estimated arrival position on the travel path by curve interpolation. Moreover, the vehicle display control device 10 changes the shape of the leading end side of the curve obtained by the curve interpolation according to the road curvature, to thereby generate an image corresponding to the road shape at the front side.

More specifically, the superimposed image is drawn so as to arrange the leading end object 70A that is capable of suggesting a direction, at the leading end of the linear shape obtained by the curve interpolation. The direction in which the leading end object 70A points is then changed in accordance with the road curvature at the front side of the vehicle 12.

Consequently, the course indicated by the superimposed image 70 is made to match with the landscape at the vehicle front side, in comparison to a case in which the travel path is illustrated using only the curve interpolation method. As a result, a sense of incongruity when the superimposed image 70 is viewed together with the landscape at the front side of the vehicle 12 can be reduced in a case in which the road ahead is curved or the like.

Although explanation has been given above regarding the vehicle display control device 10 according to the exemplary embodiment, it is obvious that various embodiments may be implemented within a range that does not depart from the spirit of the present invention. For example, the display mode of the superimposed image is not limited to that in the above-described exemplary embodiment. The linear superimposed image according to the present invention also includes a case in which plural objects are arranged in a linear shape.

Moreover, the processing executed by the CPU 30 reading and executing programs in the above-described exemplary embodiment may be executed by various types of processors other than the CPU 30. Such processors include programmable logic devices (PLD) that allow circuit configuration to be modified post-manufacture, such as a field-programmable gate array (FPGA) or the like, and dedicated electric circuits, which are processors including a circuit configuration that has been custom-designed to execute specific processing, such as an application specific integrated circuit (ASIC) or the like.

Further, the display processing may be executed by any one of these various types of processors, or by a combination of two or more of the same type or different types of processors, and, for example, may be executed by plural FPGAs, a combination of a CPU and an FPGA, or the like. Furthermore, the hardware structure of these various types of processors is, more specifically, an electric circuit combining circuit elements such as semiconductor elements or the like.

Moreover, although a configuration is provided in which various data is stored in the storage 36 in the exemplary embodiment described above, there is no limitation thereto. For example, a non-transitory recording medium such as a compact disc (CD), a digital versatile disc (DVD), a universal serial bus (USB) memory or the like may be provided as a storage section. In this case, various programs, data, and the like are stored in these recording media.

What is claimed is:

1. A vehicle display control device comprising:
at least one processor, the at least one processor being configured to:
generate a linear superimposed image indicating a travel path of a vehicle by being drawn so as to be superimposed on a landscape at a vehicle front side and extend toward the vehicle front side; and
carry out control so as to change a direction in which a leading end side of the superimposed image faces, according to a road curvature, based on road information for the vehicle front side.

2. The vehicle display control device according to claim 1, wherein:
the superimposed image indicates a travel path that accompanies a lane change; and
the processor is configured to change the direction in which the leading end side of the superimposed image, which indicates the travel path after the lane change, faces, according to the road curvature.

3. The vehicle display control device according to claim 1, wherein:
the superimposed image has a linear shape connecting a coordinate point of a current position of the vehicle and a coordinate point of an estimated arrival position on the travel path, by curve interpolation; and
the processor is configured to change a shape of a leading end side of a curved line obtained by the curve interpolation, according to the road curvature.

4. A vehicle display control method comprising:
generating a linear superimposed image indicating a travel path of a vehicle by being drawn so as to be superimposed on a landscape at a vehicle front side and extend toward the vehicle front side; and
changing a direction in which a leading end side of the superimposed image faces, according to a road curvature, based on road information for the vehicle front side.

5. A computer-readable recording medium for a vehicle, which is a computer-readable non-transitory recording medium storing a program that is executable by a processor to perform processing comprising:
generating a linear superimposed image indicating a travel path of a vehicle by being drawn so as to be superimposed on a landscape at a vehicle front side and extend toward the vehicle front side; and
changing a direction in which a leading end side of the superimposed image faces, according to a road curvature, based on road information for the vehicle front side.
